(19) United States
(12) Patent Application Publication
(10) Pub. No.: US 2006/0036971 A1
(43) Pub. Date: Feb. 16, 2006

(54) Mouse cursor display

(75) Inventors: Gili Mendel, Cary, NC (US); Rebecca J. Schaller, Cary, NC (US); Peter Allen Walker, Fuquay-Varina, NC (US); Joseph Robert Winchester, Otterbourne (GB)

Correspondence Address: Gregory M. Doudnikoff;IBM Corp., Dept. T81/Bldg. 503, PO Box 12195, Research Triangle Park, NC, 27709, US

(73) Assignee: International Business Machines Corporation, Armonk, NY (US)

(21) Appl. No.: 10/924,651

(22) Filed: Aug. 24, 2004

(30) Foreign Application Priority Data
Aug. 12, 2004 (GB) 0417957.8

(51) Int. Cl. G06F 17/00

(52) U.S. Cl. 715/856; 715/859; 715/862

(57) ABSTRACT

The present invention provides a method, data processing apparatus and computer program product which displays status information with the mouse symbol, the status information relating to an operation being performed with a mouse cursor. For example, the status information may provides position co-ordinates relating to the cursor symbol.

### FIELD OF THE INVENTION

The invention relates to display of a symbol to represent a mouse cursor on a computer display.

### BACKGROUND TO THE INVENTION

Computer based Graphical User Interface (GUI) tools, such as drawing packages or editors, allow a user to manipulate items on a display surface of a graphical window using the mouse pointer/cursor. This may involve selecting a figure or element of text and then dragging or moving it to a new location. Alternatively, it may involve selecting an item from a palette and then moving the cursor over a target location in the diagram before performing an operation to add the item to the diagram by performing a gesture such as pressing and releasing a mouse button. During one of these gestures, as the cursor is being moved and the operation is being prepared, the user is given feedback which indicates to them how the task will be performed. One form of feedback commonly found in drawing tools is to change the cursor symbol. An example of this is when the cursor symbol is changed to indicate the type of task/operation which can be performed or is being performed. For example, the cursor symbol may be changed to a North South (NS) arrow when the cursor is over the top edge of a graphic in order to indicate that this is the edge that will be moved, or to a “no entry” or “not” symbol when the operation is invalid.

Alternatively, for example, when the cursor is over an area which results in an item being moved or placed, the cursor symbol may change to a “+”, an arrow or a pen symbol depending on the operation.

Further in U.S. Pat. No. 6,437,800 an information cursor is provided which displays, with the pointing portion of the cursor symbol, information about an object which is being pointed at by the pointing portion. Such information could be the name of the object, a preview of the object or property information about the object.

Further, when an operation being performed with a cursor in a graphical package is associated with position constraints, a status bar or feedback area may be displayed in the package to show the position information pertaining to the cursor. Such position information may be used in completing the operation and could, for example, comprise an X and Y position where a drop will occur. In this situation the user has two feedback areas to look at, the cursor which they are moving, and also the status line label that contains the constraint information.

A problem with this is that it requires the user to switch vision between the two areas when performing the operation. This makes the operation relatively difficult to execute with precision, slower to complete, and further may contribute to physical eye strain.

Alternatively, in some graphical packages a separate feedback area can be shown beneath the cursor when the cursor is moved. A problem with this is that the cursor symbol can obscure this area. Further, because the cursor symbol has a very high priority in an operating system, updates to the cursor happen more quickly than updates to the feedback area made by the graphical package. As a result there is a performance lag in which the cursor can have moved and feedback displayed in the feedback area becomes stale.

### SUMMARY OF THE INVENTION

The present invention addresses this problem by providing a cursor symbol which comprises, in addition to an image which represents an operation which can be or is being performed, a further feedback area which shows additional status information pertaining to the operation.

Accordingly, according to a first aspect the invention provides a data processing method for displaying status information relating to a mouse operation with a mouse cursor, the method comprising: receiving an event which indicates that the mouse cursor has moved; creating a cursor symbol comprising: an image which provides a visual indication of an operation which can be performed with the cursor at the cursor position; and a status area which provides additional status information pertaining to the operation; and causing the cursor symbol to be displayed.

According to a second aspect the present invention provides a data processing apparatus comprising: an element which receives an event which indicates that a mouse cursor has moved; an element which creates a cursor symbol comprising: an image which provides a visual indication of an operation which can be performed with the cursor at the cursor position; and a status area which provides additional status information pertaining to the operation; and an element for causing the cursor symbol to be displayed.

According to a third aspect the present invention provides a computer program product comprising instructions which, when executed on a data processing host, cause said host to carry out a method comprising the steps of: receiving an event which indicates that the mouse cursor has moved; creating a cursor symbol comprising: an image which provides a visual indication of an operation which can be performed with the cursor at the cursor position; and a status area which provides additional status information pertaining to the operation; and causing the cursor symbol to be displayed.

Preferably, in the cursor symbol created, the relative positions of the image and status area are selected according to the current position of the cursor. This enables the status area to be displayed in a way that, for example, does not obscure other important information on the display on which the cursor symbol is to be displayed.

Preferably the status area includes position information associated with the operation. The position information could be anything which enables the position of the cursor to be determined in a manner meaningful to the operation being performed. For example position information could be X and Y co-ordinates relative to the corner of a display window, such co-ordinates being expressed, for example, as horizontal and vertical pixel counts, units of distance measurement (e.g.: millimetres), or a row and column numbers.

Alternatively the status area could include, for example, the estimated time for the operation to complete, or any other status information pertaining to the operation being performed.

### BRIEF DESCRIPTION OF THE DRAWINGS

The invention will now be described, by way of example only, with reference to a preferred embodiment thereof, as illustrated in the accompanying drawings, in which:

FIG. 1 is a block diagram of a data processing environment in which the preferred embodiment of the present invention can be advantageously applied;

FIGS. 2 and 3 show prior art situations in which the cursor symbol changes to indicate the operation(s) which can occur;

FIG. 4 shows a prior art solution for providing a user with position constraint information relating to an operation which can be performed;

FIGS. 5a to 5d show the display of a cursor symbol which is created according to the present invention and includes position information in the status area included with the cursor symbol;

FIG. 6 shows an embodiment of the invention in a Microsoft paint panel such as shown in FIG. 3; and

FIG. 7 is a flow chart of a method in which the preferred embodiment of the present invention is performed.

Note that in the drawings like reference numbers represent corresponding parts throughout.

### DESCRIPTION OF THE PREFERRED EMBODIMENT

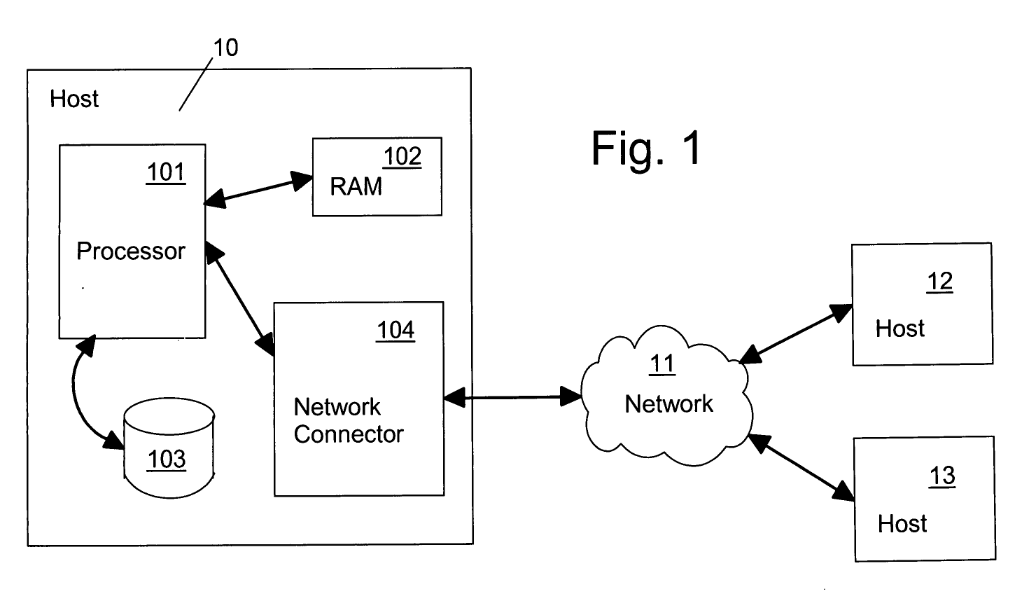

FIG. 1 is a block diagram of a data processing environment in which the preferred embodiment of the present invention can be advantageously applied. In FIG. 1, a client/server data processing host 10 is connected to other client/server data processing host 12 and 13 via a network 11, which could be, for example, the Internet. For example, a graphical user interface tool which incorporate the present invention could be executed by any of the data processing hosts. Client/server 10 has a processor 101 for executing programs that control the operation of the client/server 10, a RAM volatile memory element 102, a non-volatile memory 103, and a network connector 104 for use in interfacing with the network 11 for communication with the other client/servers 12 and 13.

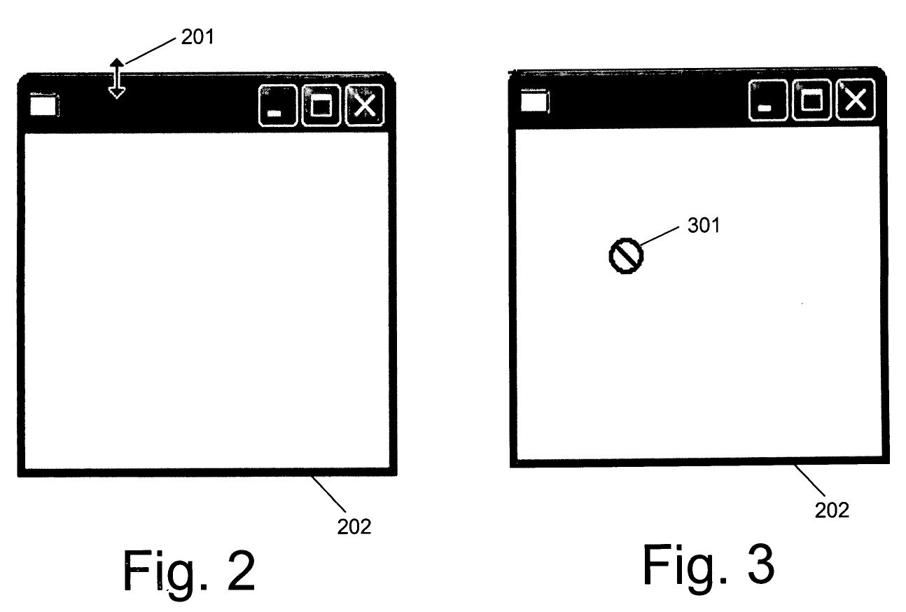

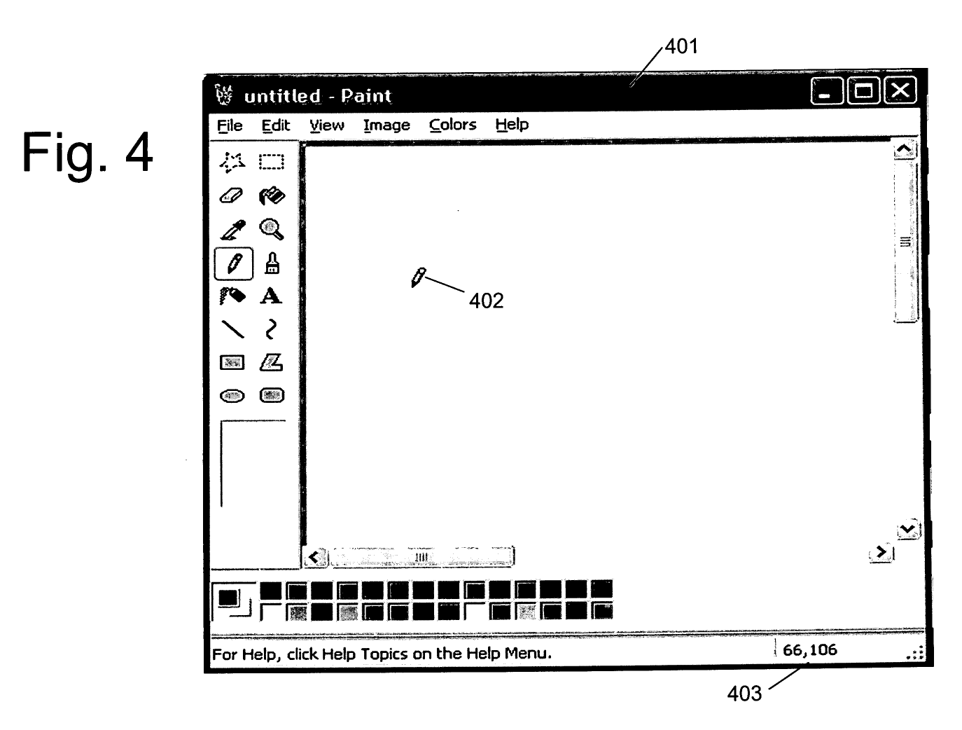

FIGS. 2 and 3 show prior art situations in which the cursor symbol changes to indicate the operation(s) which can occur. FIG. 2 shows a cursor 201 which has changed to a North South arrow because the cursor has been moved into a position at the top edge of a graphic window and to indicate that an operation could be initiated to move the edge in order to stretch or compress the height of the graphic window 202. FIG. 3 shows a cursor 301 which has changed to a “no entry” or “not” symbol because the cursor has been moved to a position in the central region of graphic window 202 and there is no operation which could be initiated from this position in the window.

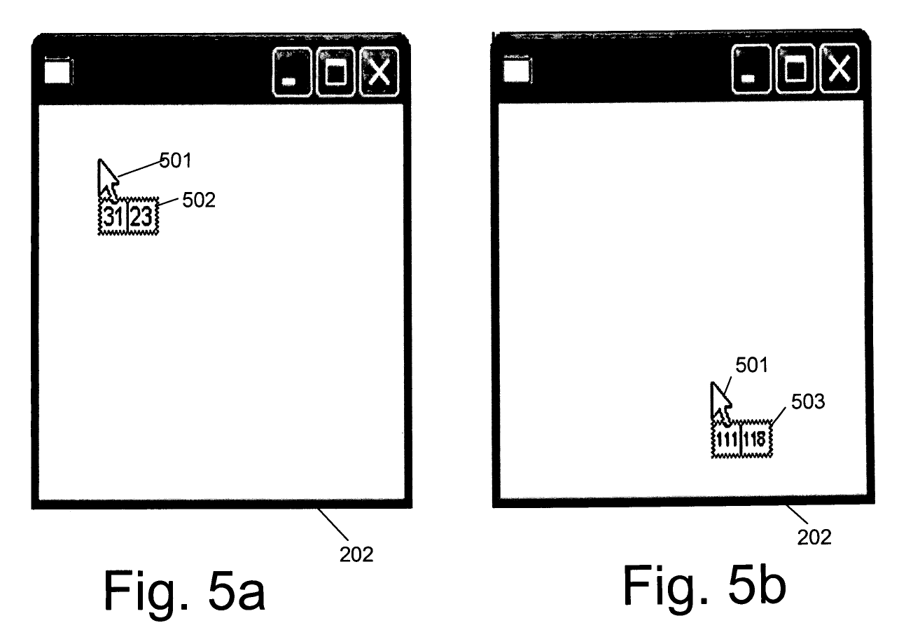

FIG. 4 shows a prior art solution for providing a user with position constraint information relating to an operation which can be performed. The figure shows a Microsoft Paint panel with the cursor, shown as a pen symbol 402 to indicate that a write operation can be performed, at position 66,106 and position constraint information shown separately from the cursor symbol in status area 401. In this solution the user has two areas to look at: the symbol of the cursor which they are moving; and the status area which contains the position constraint information. This solution requires the user to switch vision between the cursor symbol and status area which makes the operation more difficult to execute with precision, slower to complete, and also may contribute to physical eye strain.

In GUI platforms, for example Microsoft Windows and Linux GTK, the cursor symbol is an optimised resource which has priority over any other GUI element and runs in a dedicated process. This ensures that the cursor symbol is always displayed on top of any graphic window and further the cursor symbol changes rapidly to indicate available operations. The present invention makes use of these attributes of the cursor symbol by adding additional position information to the cursor symbol.

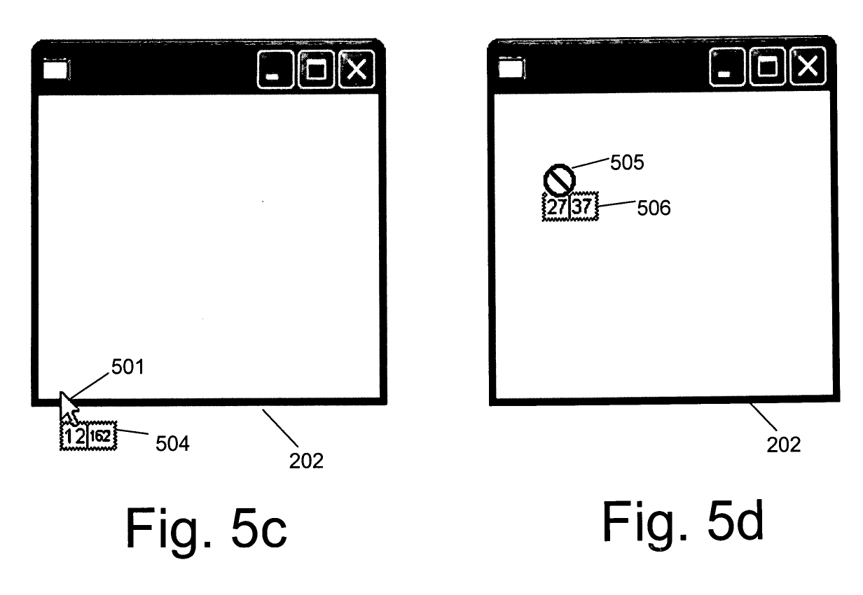

FIGS. 5a to 5d show the display of a cursor symbol which is created according to the present invention and includes position information in the status area included with the cursor symbol. In FIG. 5a the cursor is located at position 31,23 relative to the tope left corner of graphic window 202 and the cursor symbol comprises arrow symbol 501 and position information 502. Position information 502 displays the X and Y co-ordinates of the cursor position. The position information is continually updated as the cursor is moved around the display so that cursor symbol includes the X an Y co-ordinates of its current position. For example FIG. 5b shows the same display when the cursor has been moved to position 111,118 in graphic window 202. In this figure the cursor shows the same arrow symbol 501 as FIG. 5b but the position information 503 now reflects the X and Y co-ordinates of the new cursor position.

FIG. 5c shows the display when the cursor is at position 12,162 which is near to the bottom of the graphic window. In this case, because the cursor symbol has drawing priority over GUI components such as graphic windows, it is drawn on top of whatever is beneath it. Accordingly the cursor symbol is not clipped when it goes outside the bounds of the GUI itself, and position information 504 shown beyond the confines of the graphic window. FIG. 5d show the display when the cursor is at position 27,37 but the cursor symbol includes a “no entry” or “not” sign rather than an arrow as indicated in FIGS. 5a-5c.

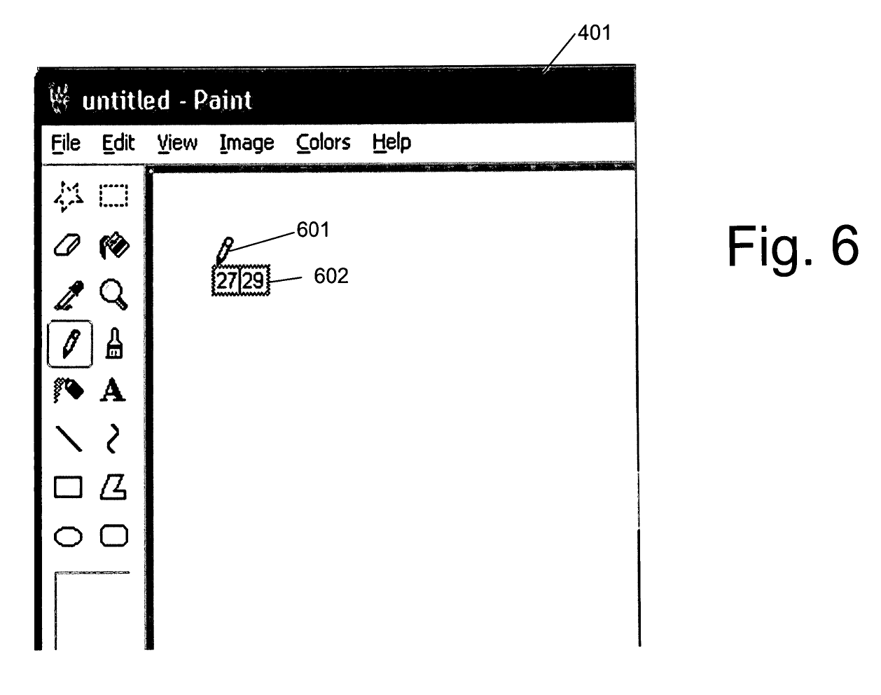

FIG. 6 shows an embodiment of the invention in a Microsoft paint panel such as shown in FIG. 3. In FIG. 6 the cursor is located at position 27,29 in Microsoft paint window 401 and as a result the cursor symbol comprises a pen symbol 601 and position information 602 to display the X an Y co-ordinates of the cursor position. This makes it very easy for the user to see the position at which a write operation is performed.

The preferred embodiment works by creating the cursor symbol during callback events which are raised by the operating system when the mouse is being moved. The cursor symbol is created with a static image and a status area containing position information. For example the static image could reflect the current usage of the cursor within a GUI tool and could be a North-South, “No-entry”, pen or arrow image as shown in FIGS. 2, 3, 4 and 5a. The position information reflects the position of the cursor at the time of the callback event and could be, for example, the X and Y co-ordinates of the cursor position relative to the top right hand corner of a work area in the GUI tool. Further each time a callback event is received the position information is updated, if necessary, to reflect the new cursor position.

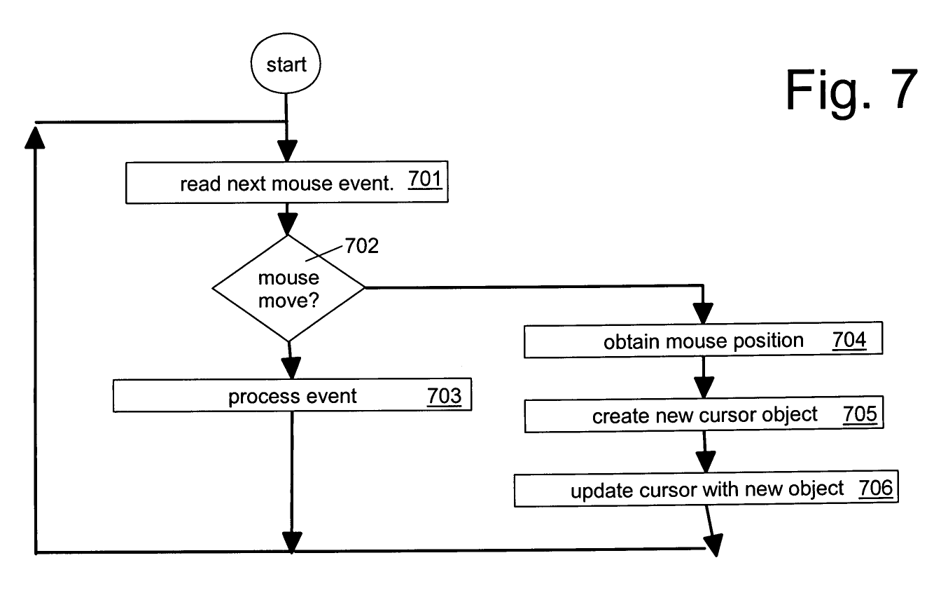

FIG. 7 shows the method used by a graphics package to update the cursor symbol according to the preferred embodiment of the present invention and is described for the Windows® operating System (The Windows operating system is a trademark of Microsoft Corporation in the United States, other countries or both). In the Windows® operating system an event is generated for each mouse event and each type of mouse event has a specific ID, for example the numeral 5 is a MOUSE_MOUVE, numeral 6 is MOUSE_ENTER, numeral 8 is MOUSE_CLICK, etc. Such events are posted to a queue from which applications, such as a graphics package, obtain the events in which they are interested. At step 701 the graphics package reads a mouse event from the queue and a step 702 checks to see if the event is a MOUSE_MOVE event. If the event is not a mouse move at step 703 the event is processed in a normal manner and such processing could, for example, involve the posting of an event to the queue, for example, to update an area of the display. If the event does relate to a MOUSE_MOVE event at step 704 the current position of the mouse is obtained by calling Display.GetCursorPos( ) which returns the absolute position of the cursor on the computer display. Once the position is known this is adjusted according to the position of the graphics package on the computer display and then at step 705 a new cursor object is created which includes an image which provides a visual indication of an operation which can be performed with the cursor at the position and a status area which provides the adjusted position as x,y co-ordinates. At step 706 the cursor is updated by calling WM_SETCURSOR which cause immediate update of the cursor symbol on the display. Whether or not the event processed was a mouse move event or not, the method returns to step 701 where the next event is read and the process continues in this manner.

In the preferred embodiment the position information comprises X and Y co-ordinates of the cursor position relative to the top left corner of the window of the graphics package. Note that the X and Y co-ordinates would be in terms of units such as a unit of distance measure (inches, fractions of an inch, millimetre, centimetre etc.) pixels, or any unit used by the GUI tool. For example, in an alternative embodiment the position information could provide a grid row and column number, such as a cell within a spreadsheet or grid based drawing program. For example the co-ordinates could be alphabetic or numeric. Further position information may be displayed relative to a different reference point such as any corner or centre of the computer or graphic package display or any other significant point on the display.

Further note that whilst FIGS. 5a-5d and 6 show the cursor symbol with the position information below and slightly to the right of the static image. However, in other embodiments the position information could be in a different position relative to the static image. Further in another embodiment the relative positioning could be changed according to the current use of the cursor or position of the cursor within the graphic tool, for example, to ensure that the position information is within the graphic window or does not cover other information which can be identified as more important than the position information. For example, with reference to FIG. 6, the position information 602 could be displayed at the opposite end of the pen symbol 601.

Note that a skilled person in the art would realise that the method described with reference to FIG. 7 could be implemented in a variety of programming languages, for example, Java™, C, and C++ (Java is a registered trademark of Sun Microsystems, Inc. in the United States, other countries, or both.). Further a skilled person would realise that once implemented the methods can be stored in a computer program product comprising one or more programs, in source or executable form, on a media, such as floppy disk, CD, and DVD, suitable for loading onto a data processing host and causing the data processing host to carry out the methods. Further a skilled person would realise that the method described with reference to 7 could be embodied in a data processing apparatus which comprises elements which carry out the method steps according to the present invention.

Accordingly, the present invention provides a method, data processing apparatus and computer program product which displays status information with the mouse symbol, the status information relating to an operation being performed with a mouse cursor. For example, the status information may provides position co-ordinates relating to the cursor symbol.

1. A data processing method for displaying status information relating to a mouse operation with a mouse cursor, the method comprising:
receiving an event which indicates that the mouse cursor has moved;
creating a cursor symbol comprising:
an image which provides a visual indication of an operation which can be performed with the cursor at the cursor position; and
a status area which provides additional status information pertaining to the operation; and
causing the cursor symbol to be displayed.

2. The method of claim 1, wherein the step of creating the cursor symbol selects the relative positions of the image and status area according to the current position of the cursor.

3. The method of claim 1 wherein the status information comprises information which describes the position of the cursor.

4. A data processing apparatus comprising:
an element which receives an event which indicates that a mouse cursor has moved;
an element which creates a cursor symbol comprising:
an image which provides a visual indication of an operation which can be performed with the cursor at the cursor position; and
a status area which provides additional status information pertaining to the operation; and
an element for causing the cursor symbol to be displayed.

5. The apparatus of claim 4, wherein the element which creates the cursor symbol selects the relative positions of the image and status area according to the current position of the cursor.

6. The apparatus of claim 3 wherein the status information comprises information which describes the position of the cursor.

7. A computer program product comprising instructions which, when executed on a data processing host, cause said host to carry out a method comprising the steps of:
receiving an event which indicates that the mouse cursor has moved;
creating a cursor symbol comprising:
an image which provides a visual indication of an operation which can be performed with the cursor at the cursor position; and
a status area which provides additional status information pertaining to the operation; and
causing the cursor symbol to be displayed.

8. The computer program product of claim 7, wherein the step of creating the cursor symbol selects the relative positions of the image and status area according to the current position of the cursor.

9. The computer program product of claim 7 wherein the status information comprises information which describes the position of the cursor.
